(19) United States
(12) Patent Application Publication
(10) Pub. No.: US 2020/0257741 A1
(43) Pub. Date: Aug. 13, 2020

(54) INTERVENTION ANALYZER FOR CONTENT DISTRIBUTION NETWORKS

(71) Applicant: Pearson Education, Inc., Bloomington, MN (US)

(72) Inventor: Kristina Marie Conlin BREAUX, San Antonio, TX (US)

(21) Appl. No.: 16/859,738

(22) Filed: Apr. 27, 2020

Related U.S. Application Data
(63) Continuation of application No. 14/984,994, filed on Dec. 30, 2015.

(51) Int. Cl. G06F 16/951; G09B 7/00

(52) U.S. Cl. CPC G06F 16/951; G09B 7/00

(57) ABSTRACT

Techniques described herein relate to initiating interventions based on individual records, using assessment data and intervention subtype profiles. Assessment data may be received from individual client devices and/or from a number of internal or external assessment data stores, and used to determine aggregate rating values for an individual record for a plurality of attributes. The individual record may be determined to be associated or not associated with each of the attributes based on the assessment data, and these associations may be compared to intervention subtype profiles to identify one or more matching intervention subtypes. Based on the matching intervention subtypes identified for individual records, customized interventions may be implemented for the individual record, including dynamic assessments, device notifications, and custom report generation.

### CROSS-REFERENCE TO RELATED APPLICATIONS

This application is continuation of U.S. patent application Ser. No. 14/984,994 entitled “INTERVENTION ANALYZER FOR CONTENT DISTRIBUTION NETWORKS” and filed on Dec. 30, 2015, the entire contents of which is incorporated herein by reference.

### BACKGROUND

Certain content distribution networks and systems may be configured to generate and present content resources such as assessment data to client devices using various different techniques. Servers in such networks and systems may receive various different types of assessment data, including data from individual client devices and/or data received from external assessment data systems. Assessment data may be sorted into individual records and analyzed in order to identify attributes associated with the individual records, as well as determine potential interventions for the individual records. However, different and diverse types of assessment data may be available in different situations, and such analyses may be performed differently within various different systems and computing environments, which may result in varying and unpredictable results during different intervention analysis sessions.

### BRIEF SUMMARY

Various techniques are described herein for initiating interventions based on individual records, using assessment data and a number of intervention subtype profiles. In some embodiments, assessment data may be received from individual client devices and/or from a number of internal or external assessment data stores. An intervention analyzer server may determine a set of attributes associated with an individual record, and may use the assessment data to determine an aggregate rating value for the individual record with respect to each attribute. The individual record may be determined to be associated or not associated with each of a plurality of attributes based on the assessment data, for example, by comparing the attribute-specific aggregate rating value to a threshold value for the attribute. The sets of attributes determined to be associated with and not associated with the individual record, then may be compared to a plurality of intervention subtype profiles to identify one or more intervention subtypes for the individual record. Based on the intervention subtypes identified for the individual record, an intervention may be initiated for the individual record, the intervention being customized/specialized with an intervention type based on the intervention subtype profiles.

Additional techniques described herein relate to receiving real-time (or near real-time) assessment data from one or more client devices at an intervention assessment device. In some embodiments, mobile devices may receive and present assessment questions to users, and answers to assessment questions may be transmitted back to an intervention assessment device and analyzed in real-time. For instance, after receiving responses to one or more assessment questions from a mobile device via a wireless protocol, an intervention assessment device may use a real-time intervention analyzer service to update the aggregate rating values and/or determinations of associations and non-associations between the various attributes and the current individual record. After each such update, the intervention assessment device may compare the updated attribute associations and non-associations with the intervention subtype profiles. In some cases, the individual record may be determined to match one or more intervention subtype profiles before receiving all possible assessment data, thereby allowing assessments to be terminated early. In other cases, the intervention assessment device may use an assessment presentation module to select subsequent assessments and/or assessment questions on-the-fly, thereby allowing assessments to be presented in a dynamic and intelligent way based on real-time feedback, in order to increase efficiency of the assessment and intervention processes.

### BRIEF DESCRIPTION OF THE DRAWINGS

FIG. 1 is a block diagram showing illustrating an example of a content distribution network.

FIG. 2 is a block diagram illustrating a computer server and computing environment within a content distribution network.

FIG. 3 is a block diagram illustrating an embodiment of one or more data store servers within a content distribution network.

FIG. 4 is a block diagram illustrating an embodiment of one or more content management servers within a content distribution network.

FIG. 5 is a block diagram illustrating the physical and logical components of a special-purpose computer device within a content distribution network.

FIG. 6 is a block diagram illustrating an example system including an intervention analyzer server, client devices, and assessment data stores, according to one or more embodiments of the disclosure.

FIG. 7 is a block diagram illustrating another example system including an intervention assessment device in communication with a number of mobile clients device, according to one or more embodiments of the disclosure.

FIG. 8 is a flow diagram illustrating an example process of initiating custom interventions for individual records based on retrieved assessment data and a set of intervention subtype profiles, according to one or more embodiments of the disclosure.

FIG. 9 is a flow diagram illustrating another example process of initiating custom interventions for individual records based on received real-time assessment data and a set of intervention subtype profiles, according to one or more embodiments of the disclosure.

FIG. 10 is an example user interface screen generated by an intervention assessment device for collecting and analyzing assessment data, according to one or more embodiments of the disclosure.

FIGS. 11A-11C are example tables representing illustrative intervention subtype profiles and intervention subtype categories, according to one or more embodiments of the disclosure.

In the appended figures, similar components and/or features may have the same reference label. Further, various compo of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides illustrative embodiment(s) only and is not intended to limit the scope, applicability or configuration of the disclosure. Rather, the ensuing description of the illustrative embodiment(s) will provide those skilled in the art with an enabling description for implementing a preferred exemplary embodiment. It is understood that various changes can be made in the function and arrangement of elements without departing from the spirit and scope as set forth in the appended claims.

Various techniques (e.g., systems, methods, computer-program products tangibly embodied in a non-transitory machine-readable storage medium, etc.) are described herein for initiating interventions based on individual records using assessment data and a number of intervention subtype profiles. In some embodiments, assessment data may be received from individual client devices and/or from a number of internal or external assessment data stores. One or more intervention analyzers, such as intervention analyzer server operating as a standalone computer server or as a specialized software service in a content distribution network, may determine a set of attributes associated with an individual record, and may use the assessment data to determine an aggregate rating value for the individual record with respect to each attribute. The individual record may be determined to be associated or not associated with each of a plurality of attributes based on the assessment data, for example, by comparing the attribute-specific aggregate rating value to a threshold value for the attribute. The sets of attributes determined to be associated with and not associated with the individual record, then may be compared to a plurality of intervention subtype profiles to identify one or more intervention subtypes for the individual record. Based on the intervention subtypes identified for the individual record, an intervention may be initiated for the individual record, the intervention being customized/specialized with an intervention type based on the intervention subtype profiles.

Additional techniques described herein relate to receiving real-time (or near real-time) assessment data at an intervention assessment device from one or more client devices. In some embodiments, mobile client devices may receive and present assessment questions to users, and may be transmit answers and other feedback to assessment questions back to an intervention assessment device, which may be analyzed in real-time. For instance, after receiving responses to one or more assessment questions from a mobile device via a wireless transmission protocol, an intervention assessment device may use a real-time intervention analyzer service to update the aggregate rating values and/or determinations of associations and non-associations between the various attributes and the current individual record. After each such update, the intervention assessment device may compare the updated attribute associations and non-associations with the intervention subtype profiles. In some cases, the individual record may be determined to match one or more intervention subtype profiles before receiving all possible assessment data, thereby allowing assessments to be terminated early. In other cases, the intervention assessment device may use an assessment presentation module to select subsequent assessments and/or assessment questions on-the-fly, thereby allowing assessments to be presented in a dynamic and intelligent way based on real-time feedback, in order to increase efficiency of the assessment and intervention processes.

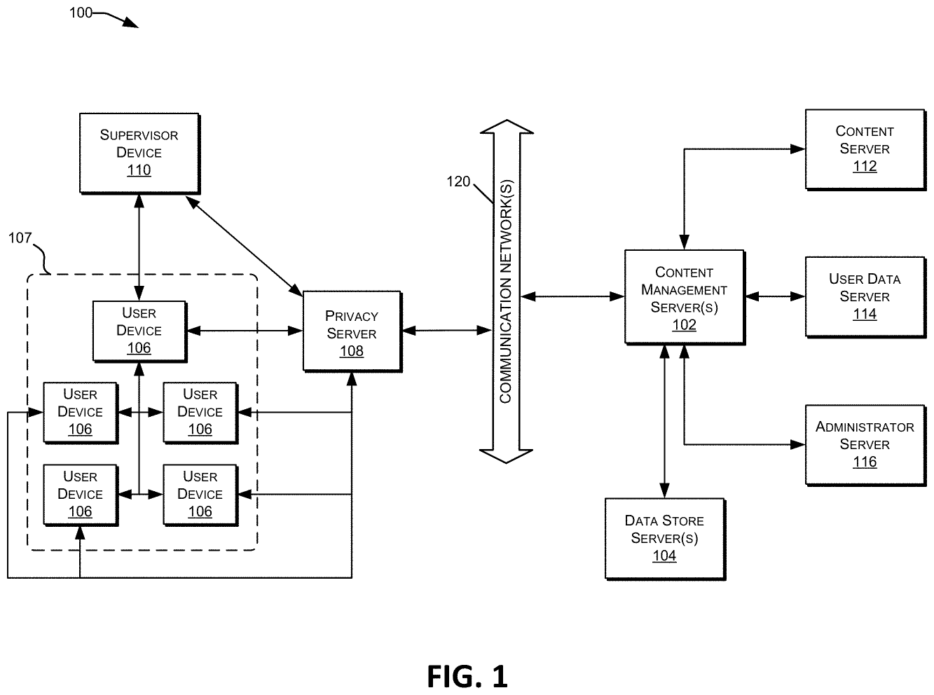

With reference now to FIG. 1, a block diagram is shown illustrating various components of a content distribution network (CDN) 100 which implements and supports certain embodiments and features described herein. Content distribution network 100 may include one or more content management servers 102. As discussed below in more detail, content management servers 102 may be any desired type of server including, for example, a rack server, a tower server, a miniature server, a blade server, a mini rack server, a mobile server, an ultra-dense server, a super server, or the like, and may include various hardware components, for example, a motherboard, a processing units, memory systems, hard drives, network interfaces, power supplies, etc. Content management server 102 may include one or more server farms, clusters, or any other appropriate arrangement and/or combination or computer servers. Content management server 102 may act according to stored instructions located in a memory subsystem of the server 102, and may run an operating system, including any commercially available server operating system and/or any other operating systems discussed herein.

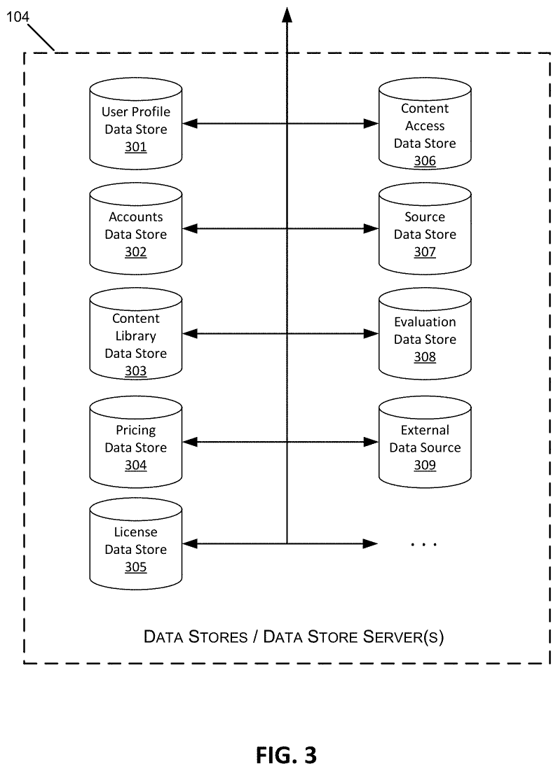

The content distribution network 100 may include one or more data store servers 104, such as database servers and file-based storage systems. Data stores 104 may comprise stored data relevant to the functions of the content distribution network 100. Illustrative examples of data stores 104 that may be maintained in certain embodiments of the content distribution network 100 are described below in reference to FIG. 3. In some embodiments, multiple data stores may reside on a single server 104, either using the same storage components of server 104 or using different physical storage components to assure data security and integrity between data stores. In other embodiments, each data store may have a separate dedicated data store server 104.

Content distribution network 100 also may include one or more user devices 106 and/or supervisor devices 110. User devices 106 and supervisor devices 110 may display content received via the content distribution network 100, and may support various types of user interactions with the content. User devices 106 and supervisor devices 110 may include mobile devices such as smartphones, tablet computers, personal digital assistants, and wearable computing devices. Such mobile devices may run a variety of mobile operating systems, and may be enabled for Internet, e-mail, short message service (SMS), Bluetooth®, mobile radio-frequency identification (M-RFID), and/or other communication protocols. Other user devices 106 and supervisor devices 110 may be general purpose personal computers or special-purpose computing devices including, by way of example, personal computers, laptop computers, workstation computers, projection devices, and interactive room display systems. Additionally, user devices 106 and supervisor devices 110 may be any other electronic devices, such as thin-client computers, Internet-enabled gaming systems, business or home appliances, and/or personal messaging devices, capable of communicating over network(s) 120.

In different contexts of content distribution networks 100, user devices 106 and supervisor devices 110 may correspond to different types of specialized devices, for example, student devices and teacher devices in an educational network, employee devices and presentation devices in a company network, different gaming devices in a gaming network, etc. In some embodiments, user devices 106 and supervisor devices 110 may operate in the same physical location 107, such as a classroom or conference room. In such cases, the devices may contain components that support direct communications with other nearby devices, such as a wireless transceivers and wireless communications interfaces, Ethernet sockets or other Local Area Network (LAN) interfaces, etc. In other implementations, the user devices 106 and supervisor devices 110 need not be used at the same location 107, but may be used in remote geographic locations in which each user device 106 and supervisor device 110 may use security features and/or specialized hardware (e.g., hardware-accelerated SSL and HTTPS, WS-Security, firewalls, etc.) to communicate with the content management server 102 and/or other remotely located user devices 106. Additionally, different user devices 106 and supervisor devices 110 may be assigned different designated roles, such as presenter devices, teacher devices, administrator devices, or the like, and in such cases the different devices may be provided with additional hardware and/or software components to provide content and support user capabilities not available to the other devices.

The content distribution network 100 also may include a privacy server 108 that maintains private user information at the privacy server 108 while using applications or services hosted on other servers. For example, the privacy server 108 may be used to maintain private data of a user within one jurisdiction even though the user is accessing an application hosted on a server (e.g., the content management server 102) located outside the jurisdiction. In such cases, the privacy server 108 may intercept communications between a user device 106 or supervisor device 110 and other devices that include private user information. The privacy server 108 may create a token or identifier that does not disclose the private information and may use the token or identifier when communicating with the other servers and systems, instead of using the user's private information.

As illustrated in FIG. 1, the content management server 102 may be in communication with one or more additional servers, such as a content server 112, a user data server 112, and/or an administrator server 116. Each of these servers may include some or all of the same physical and logical components as the content management server(s) 102, and in some cases, the hardware and software components of these servers 112-116 may be incorporated into the content management server(s) 102, rather than being implemented as separate computer servers.

Content server 112 may include hardware and software components to generate, store, and maintain the content resources for distribution to user devices 106 and other devices in the network 100. For example, in content distribution networks 100 used for professional training and educational purposes, content server 112 may include data stores of training materials, presentations, interactive programs and simulations, course models, course outlines, and various training interfaces that correspond to different materials and/or different types of user devices 106. In content distribution networks 100 used for media distribution, interactive gaming, and the like, a content server 112 may include media content files such as music, movies, television programming, games, and advertisements.

User data server 114 may include hardware and software components that store and process data for multiple users relating to each user's activities and usage of the content distribution network 100. For example, the content management server 102 may record and track each user's system usage, including their user device 106, content resources accessed, and interactions with other user devices 106. This data may be stored and processed by the user data server 114, to support user tracking and analysis features. For instance, in the professional training and educational contexts, the user data server 114 may store and analyze each user's training materials viewed, presentations attended, courses completed, interactions, evaluation results, and the like. The user data server 114 may also include a repository for user-generated material, such as evaluations and tests completed by users, and documents and assignments prepared by users. In the context of media distribution and interactive gaming, the user data server 114 may store and process resource access data for multiple users (e.g., content titles accessed, access times, data usage amounts, gaming histories, user devices and device types, etc.).

Administrator server 116 may include hardware and software components to initiate various administrative functions at the content management server 102 and other components within the content distribution network 100. For example, the administrator server 116 may monitor device status and performance for the various servers, data stores, and/or user devices 106 in the content distribution network 100. When necessary, the administrator server 116 may add or remove devices from the network 100, and perform device maintenance such as providing software updates to the devices in the network 100. Various administrative tools on the administrator server 116 may allow authorized users to set user access permissions to various content resources, monitor resource usage by users and devices 106, and perform analyses and generate reports on specific network users and/or devices (e.g., resource usage tracking reports, training evaluations, etc.).

The content distribution network 100 may include one or more communication networks 120. Although only a single network 120 is identified in FIG. 1, the content distribution network 100 may include any number of different communication networks between any of the computer servers and devices shown in FIG. 1 and/or other devices described herein. Communication networks 120 may enable communication between the various computing devices, servers, and other components of the content distribution network 100. As discussed below, various implementations of content distribution networks 100 may employ different types of networks 120, for example, computer networks, telecommunications networks, wireless networks, and/or any combination of these and/or other networks.

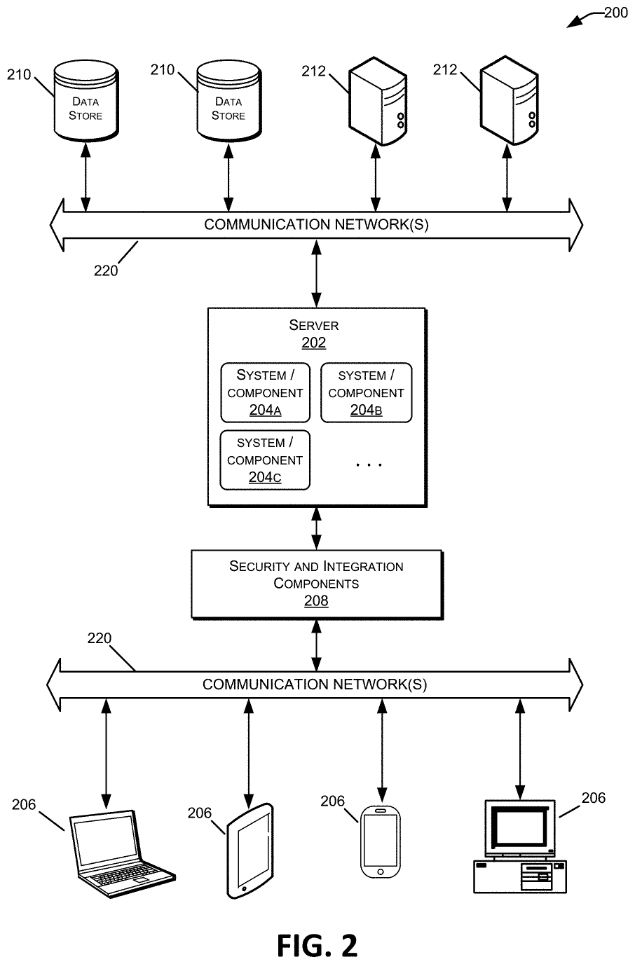

With reference to FIG. 2, an illustrative distributed computing environment 200 is shown including a computer server 202, four client computing devices 206, and other components that may implement certain embodiments and features described herein. In some embodiments, the server 202 may correspond to the content management server 102 discussed above in FIG. 1, and the client computing devices 206 may correspond to the user devices 106. However, the computing environment 200 illustrated in FIG. 2 may correspond to any other combination of devices and servers configured to implement a client-server model or other distributed computing architecture.

Client devices 206 may be configured to receive and execute client applications over one or more networks 220. Such client applications may be web browser based applications and/or standalone software applications, such as mobile device applications. Server 202 may be communicatively coupled with the client devices 206 via one or more communication networks 220. Client devices 206 may receive client applications from server 202 or from other application providers (e.g., public or private application stores). Server 202 may be configured to run one or more server software applications or services, for example, web-based or cloud-based services, to support content distribution and interaction with client devices 206. Users operating client devices 206 may in turn utilize one or more client applications (e.g., virtual client applications) to interact with server 202 to utilize the services provided by these components.

Various different subsystems and/or components 204 may be implemented on server 202. Users operating the client devices 206 may initiate one or more client applications to use services provided by these subsystems and components. The subsystems and components within the server 202 and client devices 206 may be implemented in hardware, firmware, software, or combinations thereof. Various different system configurations are possible in different distributed computing systems 200 and content distribution networks 100. The embodiment shown in FIG. 2 is thus one example of a distributed computing system and is not intended to be limiting.

Although exemplary computing environment 200 is shown with four client computing devices 206, any number of client computing devices may be supported. Other devices, such as specialized sensor devices, etc., may interact with client devices 206 and/or server 202.

As shown in FIG. 2, various security and integration components 208 may be used to send and manage communications between the server 202 and user devices 206 over one or more communication networks 220. The security and integration components 208 may include separate servers, such as web servers and/or authentication servers, and/or specialized networking components, such as firewalls, routers, gateways, load balancers, and the like. In some cases, the security and integration components 208 may correspond to a set of dedicated hardware and/or software operating at the same physical location and under the control of same entities as server 202. For example, components 208 may include one or more dedicated web servers and network hardware in a datacenter or a cloud infrastructure. In other examples, the security and integration components 208 may correspond to separate hardware and software components which may be operated at a separate physical location and/or by a separate entity.

Security and integration components 208 may implement various security features for data transmission and storage, such as authenticating users and restricting access to unknown or unauthorized users. In various implementations, security and integration components 208 may provide, for example, a file-based integration scheme or a service-based integration scheme for transmitting data between the various devices in the content distribution network 100. Security and integration components 208 also may use secure data transmission protocols and/or encryption for data transfers, for example, File Transfer Protocol (FTP), Secure File Transfer Protocol (SFTP), and/or Pretty Good Privacy (PGP) encryption.

In some embodiments, one or more web services may be implemented within the security and integration components 208 and/or elsewhere within the content distribution network 100. Such web services, including cross-domain and/or cross-platform web services, may be developed for enterprise use in accordance with various web service standards, such as RESTful web services (i.e., services based on the Representation State Transfer (REST) architectural style and constraints), and/or web services designed in accordance with the Web Service Interoperability (WS-I) guidelines. Some web services may use the Secure Sockets Layer (SSL) or Transport Layer Security (TLS) protocol to provide secure connections between the server 202 and user devices 206. SSL or TLS may use HTTP or HTTPS to provide authentication and confidentiality. In other examples, web services may be implemented using REST over HTTPS with the OAuth open standard for authentication, or using the WS-Security standard which provides for secure SOAP messages using XML encryption. In other examples, the security and integration components 208 may include specialized hardware for providing secure web services. For example, security and integration components 208 may include secure network appliances having built-in features such as hardware-accelerated SSL and HTTPS, WS-Security, and firewalls. Such specialized hardware may be installed and configured in front of any web servers, so that any external devices may communicate directly with the specialized hardware.

Communication network(s) 220 may be any type of network familiar to those skilled in the art that can support data communications using any of a variety of commercially-available protocols, including without limitation, TCP/IP (transmission control protocol/Internet protocol), SNA (systems network architecture), IPX (Internet packet exchange), Secure Sockets Layer (SSL) or Transport Layer Security (TLS) protocols, Hyper Text Transfer Protocol (HTTP) and Secure Hyper Text Transfer Protocol (HTTPS), Bluetooth®, Near Field Communication (NFC), and the like. Merely by way of example, network(s) 220 may be local area networks (LAN), such as one based on Ethernet, Token-Ring and/or the like. Network(s) 220 also may be wide-area networks, such as the Internet. Networks 220 may include telecommunication networks such as a public switched telephone networks (PSTNs), or virtual networks such as an intranet or an extranet. Infrared and wireless networks (e.g., using the Institute of Electrical and Electronics Engineers (IEEE) 802.11 protocol suite or other wireless protocols) also may be included in networks 220.

Computing environment 200 also may include one or more data stores 210 and/or back-end servers 212. In certain examples, the data stores 210 may correspond to data store server(s) 104 discussed above in FIG. 1, and back-end servers 212 may correspond to the various back-end servers 112-116. Data stores 210 and servers 212 may reside in the same datacenter or may operate at a remote location from server 202. In some cases, one or more data stores 210 may reside on a non-transitory storage medium within the server 202. Other data stores 210 and back-end servers 212 may be remote from server 202 and configured to communicate with server 202 via one or more networks 220. In certain embodiments, data stores 210 and back-end servers 212 may reside in a storage-area network (SAN), or may use storage-as-a-service (STaaS) architectural model.

With reference to FIG. 3, an illustrative set of data stores and/or data store servers is shown, corresponding to the data store servers 104 of the content distribution network 100 discussed above in FIG. 1. One or more individual data stores 301-309 may reside in storage on a single computer server 104 (or a single server farm or cluster) under the control of a single entity, or may reside on separate servers operated by different entities and/or at remote locations. In some embodiments, data stores 301-309 may be accessed by the content management server 102 and/or other devices and servers within the network 100 (e.g., user devices 106, supervisor devices 110, administrator servers 116, etc.). Access to one or more of the data stores 301-309 may be limited or denied based on the processes, user credentials, and/or devices attempting to interact with the data store.

The paragraphs below describe examples of specific data stores that may be implemented within some embodiments of a content distribution network 100. It should be understood that the below descriptions of data stores 301-309, including their functionality and types of data stored therein, are illustrative and non-limiting. Data stores server architecture, design, and the execution of specific data stores 301-309 may depend on the context, size, and functional requirements of a content distribution network 100. For example, in content distribution systems 100 used for professional training and educational purposes, separate databases or file-based storage systems may be implemented in data store server(s) 104 to store trainee and/or student data, trainer and/or professor data, training module data and content descriptions, training results, evaluation data, and the like. In contrast, in content distribution systems 100 used for media distribution from content providers to subscribers, separate data stores may be implemented in data stores server(s) 104 to store listings of available content titles and descriptions, content title usage statistics, subscriber profiles, account data, payment data, network usage statistics, etc.

A user profile data store 301 may include information relating to the end users within the content distribution network 100. This information may include user characteristics such as the user names, access credentials (e.g., logins and passwords), user preferences, and information relating to any previous user interactions within the content distribution network 100 (e.g., requested content, posted content, content modules completed, training scores or evaluations, other associated users, etc.).

An accounts data store 302 may generate and store account data for different users in various roles within the content distribution network 100. For example, accounts may be created in an accounts data store 302 for individual end users, supervisors, administrator users, and entities such as companies or educational institutions. Account data may include account types, current account status, account characteristics, and any parameters, limits, restrictions associated with the accounts.

A content library data store 303 may include information describing the individual content items (or content resources) available via the content distribution network 100. In some embodiments, the library data store 303 may include metadata, properties, and other characteristics associated with the content resources stored in the content server 112. Such data may identify one or more aspects or content attributes of the associated content resources, for example, subject matter, access level, or skill level of the content resources, license attributes of the content resources (e.g., any limitations and/or restrictions on the licensable use and/or distribution of the content resource), price attributes of the content resources (e.g., a price and/or price structure for determining a payment amount for use or distribution of the content resource), rating attributes for the content resources (e.g., data indicating the evaluation or effectiveness of the content resource), and the like. In some embodiments, the library data store 303 may be configured to allow updating of content metadata or properties, and to allow the addition and/or removal of information relating to the content resources. For example, content relationships may be implemented as graph structures, which may be stored in the library data store 303 or in an additional store for use by selection algorithms along with the other metadata.

A pricing data store 304 may include pricing information and/or pricing structures for determining payment amounts for providing access to the content distribution network 100 and/or the individual content resources within the network 100. In some cases, pricing may be determined based on a user's access to the content distribution network 100, for example, a time-based subscription fee, or pricing based on network usage and. In other cases, pricing may be tied to specific content resources. Certain content resources may have associated pricing information, whereas other pricing determinations may be based on the resources accessed, the profiles and/or accounts of the user, and the desired level of access (e.g., duration of access, network speed, etc.). Additionally, the pricing data store 304 may include information relating to compilation pricing for groups of content resources, such as group prices and/or price structures for groupings of resources.

A license data store 305 may include information relating to licenses and/or licensing of the content resources within the content distribution network 100. For example, the license data store 305 may identify licenses and licensing terms for individual content resources and/or compilations of content resources in the content server 112, the rights holders for the content resources, and/or common or large-scale right holder information such as contact information for rights holders of content not included in the content server 112.

A content access data store 306 may include access rights and security information for the content distribution network 100 and specific content resources. For example, the content access data store 306 may include login information (e.g., user identifiers, logins, passwords, etc.) that can be verified during user login attempts to the network 100. The content access data store 306 also may be used to store assigned user roles and/or user levels of access. For example, a user's access level may correspond to the sets of content resources and/or the client or server applications that the user is permitted to access. Certain users may be permitted or denied access to certain applications and resources based on their subscription level, training program, course/grade level, etc. Certain users may have supervisory access over one or more end users, allowing the supervisor to access all or portions of the end user's content, activities, evaluations, etc. Additionally, certain users may have administrative access over some users and/or some applications in the content management network 100, allowing such users to add and remove user accounts, modify user access permissions, perform maintenance updates on software and servers, etc.

A source data store 307 may include information relating to the source of the content resources available via the content distribution network. For example, a source data store 307 may identify the authors and originating devices of content resources, previous pieces of data and/or groups of data originating from the same authors or originating devices, and the like.

An evaluation data store 308 may include information used to direct the evaluation of users and content resources in the content management network 100. In some embodiments, the evaluation data store 308 may contain, for example, the analysis criteria and the analysis guidelines for evaluating users (e.g., trainees/students, gaming users, media content consumers, etc.) and/or for evaluating the content resources in the network 100. The evaluation data store 308 also may include information relating to evaluation processing tasks, for example, the identification of users and user devices 106 that have received certain content resources or accessed certain applications, the status of evaluations or evaluation histories for content resources, users, or applications, and the like. Evaluation criteria may be stored in the evaluation data store 308 including data and/or instructions in the form of one or several electronic rubrics or scoring guides for use in the evaluation of the content, users, or applications. The evaluation data store 308 also may include past evaluations and/or evaluation analyses for users, content, and applications, including relative rankings, characterizations, explanations, and the like.

In addition to the illustrative data stores described above, data store server(s) 104 (e.g., database servers, file-based storage servers, etc.) may include one or more external data aggregators 309. External data aggregators 309 may include third-party data sources accessible to the content management network 100, but not maintained by the content management network 100. External data aggregators 309 may include any electronic information source relating to the users, content resources, or applications of the content distribution network 100. For example, external data aggregators 309 may be third-party data stores containing demographic data, education related data, consumer sales data, health related data, and the like. Illustrative external data aggregators 309 may include, for example, social networking web servers, public records data stores, learning management systems, educational institution servers, business servers, consumer sales data stores, medical record data stores, etc. Data retrieved from various external data aggregators 309 may be used to verify and update user account information, suggest user content, and perform user and content evaluations.

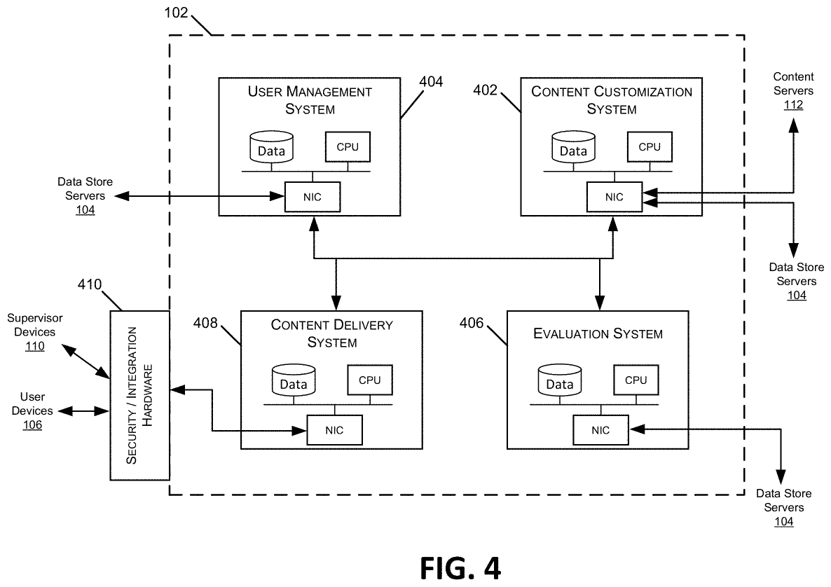

With reference now to FIG. 4, a block diagram is shown illustrating an embodiment of one or more content management servers 102 within a content distribution network 100. As discussed above, content management server(s) 102 may include various server hardware and software components that manage the content resources within the content distribution network 100 and provide interactive and adaptive content to users on various user devices 106. For example, content management server(s) 102 may provide instructions to and receive information from the other devices within the content distribution network 100, in order to manage and transmit content resources, user data, and server or client applications executing within the network 100.

A content management server 102 may include a content customization system 402. The content customization system 402 may be implemented using dedicated hardware within the content distribution network 100 (e.g., a content customization server 402), or using designated hardware and software resources within a shared content management server 102. In some embodiments, the content customization system 402 may adjust the selection and adaptive capabilities of content resources to match the needs and desires of the users receiving the content. For example, the content customization system 402 may query various data stores and servers 104 to retrieve user information, such as user preferences and characteristics (e.g., from a user profile data store 301), user access restrictions to content recourses (e.g., from a content access data store 306), previous user results and content evaluations (e.g., from an evaluation data store 308), and the like. Based on the retrieved information from data stores 104 and other data sources, the content customization system 402 may modify content resources for individual users.

A content management server 102 also may include a user management system 404. The user management system 404 may be implemented using dedicated hardware within the content distribution network 100 (e.g., a user management server 404), or using designated hardware and software resources within a shared content management server 102. In some embodiments, the user management system 404 may monitor the progress of users through various types of content resources and groups, such as media compilations, courses or curriculums in training or educational contexts, interactive gaming environments, and the like. For example, the user management system 404 may query one or more databases and/or data store servers 104 to retrieve user data such as associated content compilations or programs, content completion status, user goals, results, and the like.

A content management server 102 also may include an evaluation system 406. The evaluation system 406 may be implemented using dedicated hardware within the content distribution network 100 (e.g., an evaluation server 406), or using designated hardware and software resources within a shared content management server 102. The evaluation system 406 may be configured to receive and analyze information from user devices 106. For example, various ratings of content resources submitted by users may be compiled and analyzed, and then stored in a data store (e.g., a content library data store 303 and/or evaluation data store 308) associated with the content. In some embodiments, the evaluation server 406 may analyze the information to determine the effectiveness or appropriateness of content resources with, for example, a subject matter, an age group, a skill level, or the like. In some embodiments, the evaluation system 406 may provide updates to the content customization system 402 or the user management system 404, with the attributes of one or more content resources or groups of resources within the network 100. The evaluation system 406 also may receive and analyze user evaluation data from user devices 106, supervisor devices 110, and administrator servers 116, etc. For instance, evaluation system 406 may receive, aggregate, and analyze user evaluation data for different types of users (e.g., end users, supervisors, administrators, etc.) in different contexts (e.g., media consumer ratings, trainee or student comprehension levels, teacher effectiveness levels, gamer skill levels, etc.).

A content management server 102 also may include a content delivery system 408. The content delivery system 408 may be implemented using dedicated hardware within the content distribution network 100 (e.g., a content delivery server 408), or using designated hardware and software resources within a shared content management server 102. The content delivery system 408 may receive content resources from the content customization system 402 and/or from the user management system 404, and provide the resources to user devices 106. The content delivery system 408 may determine the appropriate presentation format for the content resources based on the user characteristics and preferences, and/or the device capabilities of user devices 106. If needed, the content delivery system 408 may convert the content resources to the appropriate presentation format and/or compress the content before transmission. In some embodiments, the content delivery system 408 may also determine the appropriate transmission media and communication protocols for transmission of the content resources.

In some embodiments, the content delivery system 408 may include specialized security and integration hardware 410, along with corresponding software components to implement the appropriate security features content transmission and storage, to provide the supported network and client access models, and to support the performance and scalability requirements of the network 100. The security and integration layer 410 may include some or all of the security and integration components 208 discussed above in FIG. 2, and may control the transmission of content resources and other data, as well as the receipt of requests and content interactions, to and from the user devices 106, supervisor devices 110, administrative servers 116, and other devices in the network 100.

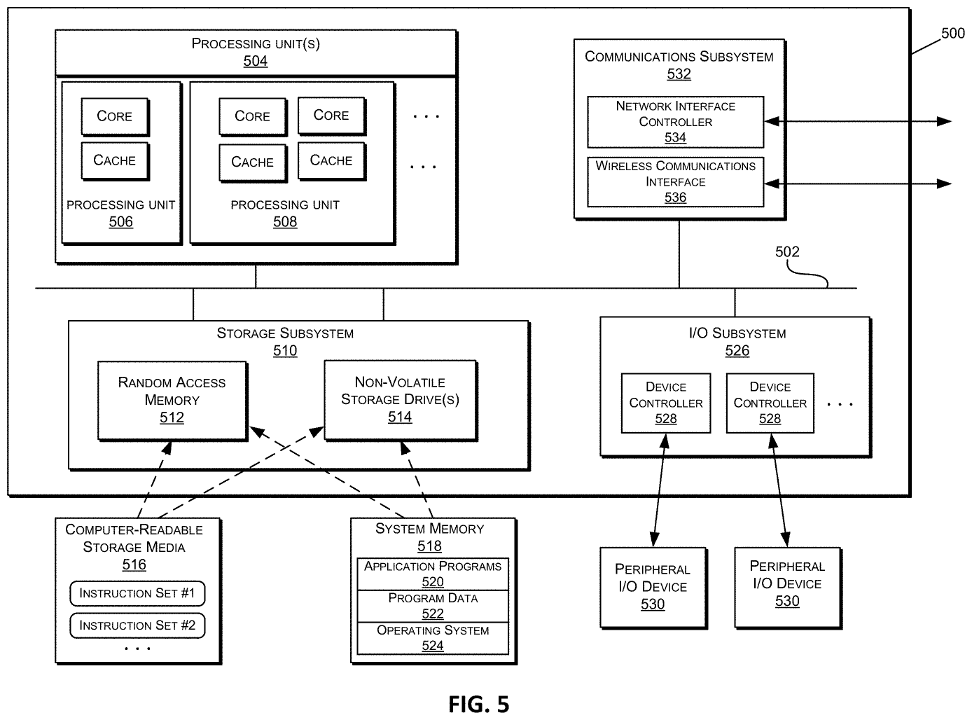

With reference now to FIG. 5, a block diagram of an illustrative computer system is shown. The system 500 may correspond to any of the computing devices or servers of the content distribution network 100 described above, or any other computing devices described herein. In this example, computer system 500 includes processing units 504 that communicate with a number of peripheral subsystems via a bus subsystem 502. These peripheral subsystems include, for example, a storage subsystem 510, an I/O subsystem 526, and a communications subsystem 532.

Bus subsystem 502 provides a mechanism for letting the various components and subsystems of computer system 500 communicate with each other as intended. Although bus subsystem 502 is shown schematically as a single bus, alternative embodiments of the bus subsystem may utilize multiple buses. Bus subsystem 502 may be any of several types of bus structures including a memory bus or memory controller, a peripheral bus, and a local bus using any of a variety of bus architectures. Such architectures may include, for example, an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 504, which may be implemented as one or more integrated circuits (e.g., a conventional microprocessor or microcontroller), controls the operation of computer system 500. One or more processors, including single core and/or multicore processors, may be included in processing unit 504. As shown in the figure, processing unit 504 may be implemented as one or more independent processing units 506 and/or 508 with single or multicore processors and processor caches included in each processing unit. In other embodiments, processing unit 504 may also be implemented as a quad-core processing unit or larger multicore designs (e.g., hexa-core processors, octo-core processors, ten-core processors, or greater.

Processing unit 504 may execute a variety of software processes embodied in program code, and may maintain multiple concurrently executing programs or processes. At any given time, some or all of the program code to be executed can be resident in processor(s) 504 and/or in storage subsystem 510. In some embodiments, computer system 500 may include one or more specialized processors, such as digital signal processors (DSPs), outboard processors, graphics processors, application-specific processors, and/or the like.

I/O subsystem 526 may include device controllers 528 for one or more user interface input devices and/or user interface output devices 530. User interface input and output devices 530 may be integral with the computer system 500 (e.g., integrated audio/video systems, and/or touchscreen displays), or may be separate peripheral devices which are attachable/detachable from the computer system 500.

Input devices 530 may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. Input devices 530 may also include three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additional input devices 530 may include, for example, motion sensing and/or gesture recognition devices that enable users to control and interact with an input device through a natural user interface using gestures and spoken commands, eye gesture recognition devices that detect eye activity from users and transform the eye gestures as input into an input device, voice recognition sensing devices that enable users to interact with voice recognition systems through voice commands, medical imaging input devices, MIDI keyboards, digital musical instruments, and the like.

Output devices 530 may include one or more display subsystems, indicator lights, or non-visual displays such as audio output devices, etc. Display subsystems may include, for example, cathode ray tube (CRT) displays, flat-panel devices, such as those using a liquid crystal display (LCD) or plasma display, light-emitting diode (LED) displays, projection devices, touch screens, and the like. In general, use of the term “output device” is intended to include all possible types of devices and mechanisms for outputting information from computer system 500 to a user or other computer. For example, output devices 530 may include, without limitation, a variety of display devices that visually convey text, graphics and audio/video information such as monitors, printers, speakers, headphones, automotive navigation systems, plotters, voice output devices, and modems.

Computer system 500 may comprise one or more storage subsystems 510, comprising hardware and software components used for storing data and program instructions, such as system memory 518 and computer-readable storage media 516. The system memory 518 and/or computer-readable storage media 516 may store program instructions that are loadable and executable on processing units 504, as well as data generated during the execution of these programs.

Depending on the configuration and type of computer system 500, system memory 318 may be stored in volatile memory (such as random access memory (RAM) 512) and/or in non-volatile storage drives 514 (such as read-only memory (ROM), flash memory, etc.) The RAM 512 may contain data and/or program modules that are immediately accessible to and/or presently being operated and executed by processing units 504. In some implementations, system memory 518 may include multiple different types of memory, such as static random access memory (SRAM) or dynamic random access memory (DRAM). In some implementations, a basic input/output system (BIOS), containing the basic routines that help to transfer information between elements within computer system 500, such as during start-up, may typically be stored in the non-volatile storage drives 514. By way of example, and not limitation, system memory 518 may include application programs 520, such as client applications, Web browsers, mid-tier applications, server applications, etc., program data 522, and an operating system 524.

Storage subsystem 510 also may provide one or more tangible computer-readable storage media 516 for storing the basic programming and data constructs that provide the functionality of some embodiments. Software (programs, code modules, instructions) that when executed by a processor provide the functionality described herein may be stored in storage subsystem 510. These software modules or instructions may be executed by processing units 504. Storage subsystem 510 may also provide a repository for storing data used in accordance with the present invention.

Storage subsystem 300 may also include a computer-readable storage media reader that can further be connected to computer-readable storage media 516. Together and, optionally, in combination with system memory 518, computer-readable storage media 516 may comprehensively represent remote, local, fixed, and/or removable storage devices plus storage media for temporarily and/or more permanently containing, storing, transmitting, and retrieving computer-readable information.

Computer-readable storage media 516 containing program code, or portions of program code, may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computer system 500.

By way of example, computer-readable storage media 516 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 516 may include, but is not limited to, Zip® drives, flash memory cards, universal serial bus (USB) flash drives, secure digital (SD) cards, DVD disks, digital video tape, and the like. Computer-readable storage media 516 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 500.

Communications subsystem 532 may provide a communication interface from computer system 500 and external computing devices via one or more communication networks, including local area networks (LANs), wide area networks (WANs) (e.g., the Internet), and various wireless telecommunications networks. As illustrated in FIG. 5, the communications subsystem 532 may include, for example, one or more network interface controllers (NICs) 534, such as Ethernet cards, Asynchronous Transfer Mode NICs, Token Ring NICs, and the like, as well as one or more wireless communications interfaces 536, such as wireless network interface controllers (WNICs), wireless network adapters, and the like. Additionally and/or alternatively, the communications subsystem 532 may include one or more modems (telephone, satellite, cable, ISDN), synchronous or asynchronous digital subscriber line (DSL) units, FireWire® interfaces, USB® interfaces, and the like. Communications subsystem 536 also may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components.

The various physical components of the communications subsystem 532 may be detachable components coupled to the computer system 500 via a computer network, a FireWire® bus, or the like, and/or may be physically integrated onto a motherboard of the computer system 500. Communications subsystem 532 also may be implemented in whole or in part by software.

In some embodiments, communications subsystem 532 may also receive input communication in the form of structured and/or unstructured data feeds, event streams, event updates, and the like, on behalf of one or more users who may use or access computer system 500. For example, communications subsystem 532 may be configured to receive data feeds in real-time from users of social networks and/or other communication services, web feeds such as Rich Site Summary (RSS) feeds, and/or real-time updates from one or more third party information sources (e.g., data aggregators 309). Additionally, communications subsystem 532 may be configured to receive data in the form of continuous data streams, which may include event streams of real-time events and/or event updates (e.g., sensor data applications, financial tickers, network performance measuring tools, clickstream analysis tools, automobile traffic monitoring, etc.). Communications subsystem 532 may output such structured and/or unstructured data feeds, event streams, event updates, and the like to one or more data stores 104 that may be in communication with one or more streaming data source computers coupled to computer system 500.

Due to the ever-changing nature of computers and networks, the description of computer system 500 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

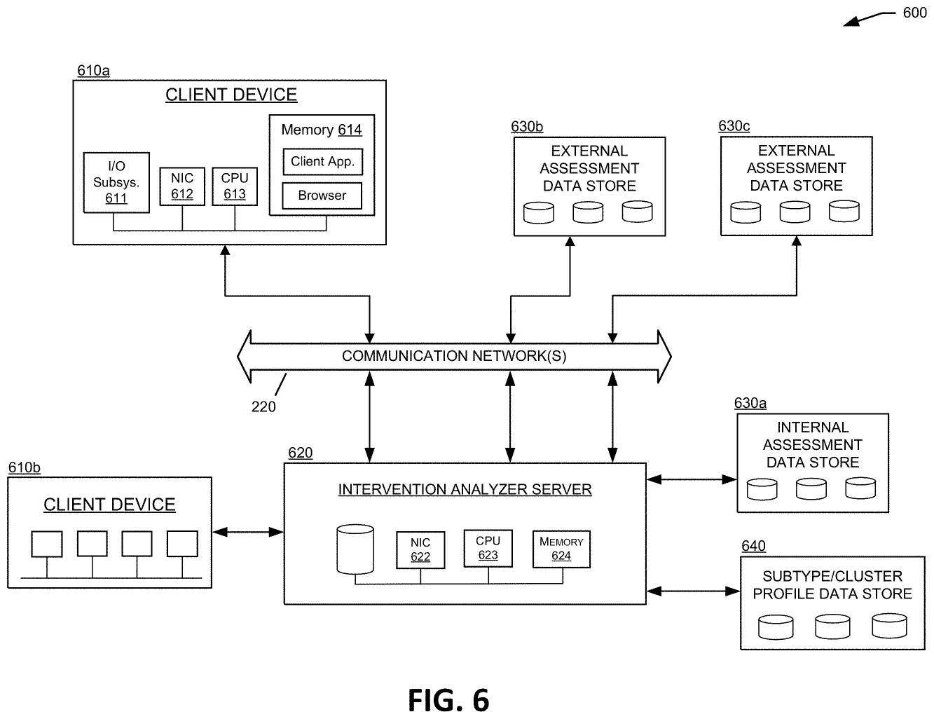

With reference now to FIG. 6, a block diagram is shown illustrating an example of an intervention analyzer system 600. As shown in this example, an intervention analyzer system 600 may include one or more client devices 610 configured to communicate with an intervention analyzer server 620. As discussed below, client devices 610 may be configured to receive assessment data input and transmit assessment data to the intervention analyzer server 620. Client devices 610 also may interact with the intervention analyzer server 620 via one or more interfaces provided by the intervention analyzer server 620, including graphical interfaces and/or programmatic interfaces, to initiate intervention analyses for individual records based on the assessment data for that individual record. The intervention analyzer server 620 may be configured to receive assessment data from client devices 610, and retrieve assessment data from various assessment data stores 630, including both internal assessment data stores 630a and external assessment data stores 630b and 630c. Based on the received/retrieved assessment data the intervention analyzer server 620 may determine a set of associated attributes from the individual record, compare the associated attributes to a plurality of intervention subtype and/or cluster profiles 640, and then initiate interventions for the individual record as described below.

As used herein, assessment data may refer to data relating to the abilities, behaviors, and/or achievements of various users within a content distribution network 100. In various implementations, intervention analyzer systems 600 may be integrated within, or configured to operate in collaboration with, one or more content distribution networks 100. For example, system 600 may be the same as, or may operate within or in collaboration with, any of the content distribution network (CDNs) 100 described above. Thus, specific examples of intervention analyzer systems 600 may include, without limitation, educational and professional training systems and networks, interactive gaming systems and networks, media distribution systems and networks, and enterprise application systems and networks, web-based applications and other Internet-based systems and networks. For example, within educational and/or professional training systems and networks 100, assessment data may include test data used to assess a range of academics skills and/or particular areas of need for the system user. For instance, students or trainees in such eLearning systems and networks 100 may be evaluated with respect to basic academic skills, including reading, mathematics, writing, and oral language skills. Examples of assessment within eLearning systems and networks 100 may include, for instance, one or more of the Kaufman Test of Educational Achievement (KTEA) assessments, and one or more of the Wechsler Individual Achievement Test (WIAT) assessments, among others. However, in other various implementations of intervention analyzer systems 600 as (or integrated into) CDNs 100, the assessment data may correspond to various other data such as evaluation or survey data (e.g., in web applications or online Internet-based CDNs 100), or product/media feedback items and assessment data (e.g., in interactive gaming or media distribution CDNs 100), and the like. Other various examples are possible, and it should be understood that the specific types of assessment data, attributes, and intervention subtype/cluster profiles are illustrative and non-limiting.

In various embodiments described herein, intervention determinations based on assessment data may be performed in context-specific intervention analyzer systems 600 and CDNs 100, such as an eLearning intervention analyzer system 600 and eLearning CDN 100. In an eLearning intervention analyzer system, eLearning system assessment data may be analyzed for individual users (e.g., employees, trainees, students, program participants, etc.) or groups of users, assessment aggregations and other calculations may be performed for the users or groups, and determinations may be made regarding potential interventions (e.g., user notifications, assessment reports, intervention recommendations, etc.) based on the calculations of the eLearning intervention analyzer system 600. Similar assessment-based intervention determinations may be performed in other types of context-specific intervention analyzer systems 600, such as interactive gaming intervention analyzer systems, media distribution intervention analyzer systems, eCommerce intervention analyzer system, etc.

Accordingly, in some embodiments, intervention analyzer servers 620 may be implemented within one or more content management servers 102 and/or other CDN servers, internal assessment data stores 630 and subtype/cluster profile data stores 640 may be implemented within one or more content servers 112, and/or data store servers 104, and client devices 610 may correspond to the user devices 106 and 110 described above in reference to CDN 100. Thus, within intervention analyzer system 600 (which may also be referred to as CDN 600 when describing certain embodiments), client devices 610 may interact with an intervention analyzer server 620 to analyze assessment data and initiate interventions for individual records using the hardware and software components of the user devices 610 and/or intervention analyzer server 620, and store/retrieve assessment data objects in one or more assessment data stores 630 (e.g., data store servers 104, content servers 112). In other examples, an intervention analyzer server 620 may be implemented using one or more computer servers, and other specialized hardware and software components, separately from any other CDN components such as content servers 112, content management servers 102, data store servers 104, and the like. In these examples, the intervention analyzer server 620 may be configured to communicate directly with client devices 610, or indirectly through content management servers 102 and/or other components and communications networks of the CDN 600.

In order to perform these features and other functionality described herein, each of the components and sub-components discussed in the example intervention analyzer system 600 may correspond to a single computer server or a complex computing system including a combination of computing devices, storage devices, network components, etc. Each of these components and their respective subcomponents may be implemented in hardware, software, or a combination thereof. Certain client devices (e.g., 610b) may communicate directly with the intervention analyzer server 620, while other client devices (e.g., 610a) may communicate with the intervention analyzer server 620 indirectly via one or more intermediary network components (e.g., routers, gateways, firewalls, etc.) or other devices (e.g., content management servers 102, content servers 112, etc.). Although the physical network components have not been shown in this example so as not to obscure the other elements depicted in the figure, it should be understood that any of the network hardware components and network architecture designs may be implemented in various embodiments to support communication between the servers and devices in the system 600. Additionally, different client devices 610 may use different networks and networks types to communicate with the intervention analyzer server 620, including one or more telecommunications networks, cable networks, satellite networks, cellular networks and other wireless networks, and computer-based IP networks, and the like. Further, certain components within intervention analyzer system 600 may include special purpose hardware devices and /or special purpose software, such as those included in I/O subsystems 611 and client application memory 614 of the client devices 610, as well as those within the memory 624 of the intervention analyzer server 620, and assessment data stores 630 and intervention subtype/cluster profile data stores 640 associated with the intervention analyzer server 620, discussed below.

Although this functionality may be described below in terms of a client-server model, such as the example intervention analyzer system 600, it should be understood that other computing environments and various combinations of servers and devices may be used to perform the functionality described herein in other examples. For instance, although the presentation and retrieval of assessment data, the determination and initiation of interventions, as well as other features described below, may be performed by a web server (e.g., intervention analyzer server 620) in collaboration with a client application (e.g., web browser or standalone client software) executing on client devices 610, in other cases these techniques may be performed entirely by a specialized intervention analyzer server 620, or entirely by an intervention assessment and/or analyzer tool (e.g., software service) executing on a client device 610. In other examples, a client-server model may be used as shown in system 600, but different functional components and processing tasks may be allocated to the client-side or the sever-side in different embodiments. Additionally, the assessment data stores 630 and/or the intervention subtype/cluster profile data store 640 may be implemented as separate servers or storage systems in some cases, and may use independent hardware and software service components. However, in other implementations, some or all of the internal assessment data stores 630 and/or intervention subtype/cluster profile data stores 640 may be incorporated into the intervention analyzer server 620 and/or client devices 610.

Client devices 610 may include desktop or laptop computers, smartphones, tablet computers, and other various types of computing devices, each of which may include some or all of the hardware, software, and networking components discussed above. Specifically, a client device 610 may be any computing device with sufficient processing components, memory and software components, and I/O system components for interacting with users and with the intervention analyzer server 620 to receive/transmit assessment data, and/or to determine and initiate interventions as described herein. Accordingly, client devices 610 may include the necessary hardware and software components to establish the network interfaces, security and authentication capabilities, and capabilities for assessment item storage, validation, and testing. In this example, client devices 610 each include an I/O subsystem 611, network interface controller 612, a processing unit 613, a memory 614 configured to operate client software applications. Client device 610 may be configured to receive and execute various programmatic and graphical interfaces for presenting assessments and receiving assessment question responsive inputs from users, as well as receiving and instantiating the processes for determining and initiating interventions on individual records. Accordingly, each I/O subsystem 611 may include hardware and software components to support a specific set of output capabilities (e.g., LCD display screen characteristics, screen size, color display, video driver, speakers, audio driver, graphics processor and drivers, etc.), and a specific set of input capabilities (e.g., keyboard, mouse, touchscreen, voice control, cameras, facial recognition, gesture recognition, etc.). Different client devices 610 may support different input and output capabilities within their I/O subsystems 611, and thus different types of interactions, user assessments, and/or interventions may be compatible or incompatible with certain client devices 610. For example, certain types of assessments and/or intervention outputs may require specific types of processors, graphics components, network components, or I/O components in order to be optimally designed and constructed using a client device 610. In some embodiments, users may establish user-specific preferences for constructing and generating specific types of assessments and intervention interfaces on specific types of client devices 610.

In some embodiments, the intervention analyzer server 620 may generate and provide the software interfaces (e.g., via a web-based application or other programmatic or graphical interface techniques) used by a client device 610 to perform user assessments and/or to intervention analyses based on assessment data. In response to receiving inputs from a client device 610 corresponding to selections of assessments, attributes, intervention profiles, etc., the intervention analyzer server 620 may retrieve the underlying assessment data objects and perform the intervention analyses described herein. As shown in this example, intervention analyzer server 620 also may establish communication sessions with additional servers, storage libraries, and other computing devices, such as internal and external assessment data stores 630, and/or intervention subtype/cluster profile data stores 640. In order to perform the tasks described herein, intervention analyzer servers 620 may include components such as network interface controllers 622, processing units 623, and memory 624 configured to store server software, handle authentication and security, and store/retrieve assessment items from data stores 640. The intervention analyzer server 620, internal assessment data store 630a, and intervention subtype/cluster profile data store 640, may be implemented as separate software (and/or storage) components within a single computer server 620 in some examples, while in other examples may be implemented as separate computer servers/systems having separate dedicated processing units, storage devices, and/or network components.

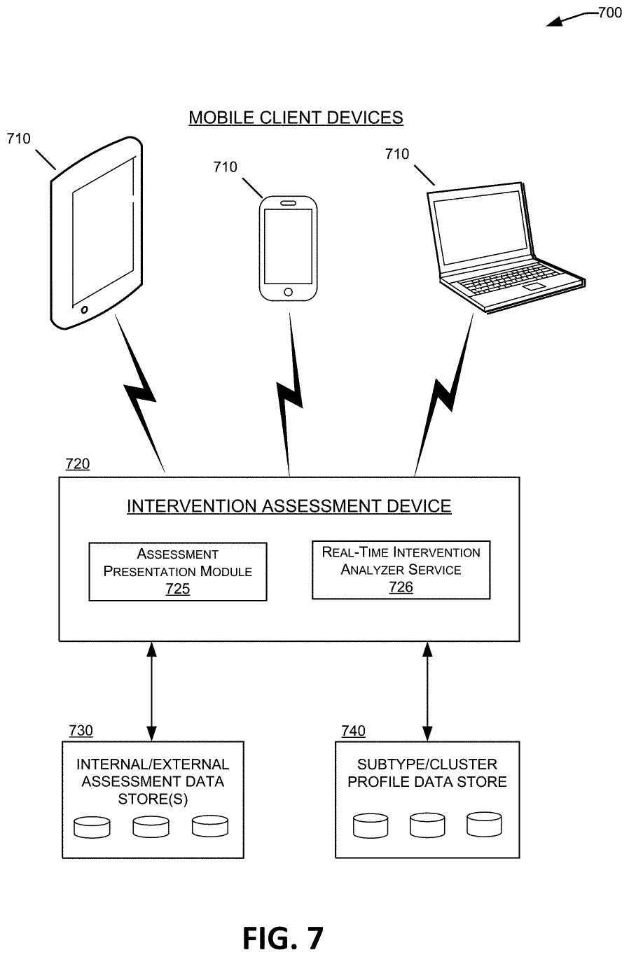

Referring now to FIG. 7, a block diagram is shown illustrating an example real-time assessment and assessment-based intervention system 700. In this example, intervention system 700 includes a number of client devices 710, and an intervention assessment device 720. In this example, the intervention assessment device 720 may be configured to generate and transmit assessments (e.g., academic skills and ability assessments in educational and professional training systems 100, etc.) to client devices 710, receive assessment data (e.g., user responses to assessment questions, etc.) from the client devices 710, and analyze the assessment data in real-time (or near real-time) in order to determine and initiate the appropriate intervention(s) for the individual user.

Various embodiments of intervention systems 700 may be integrated within (or configured to operate in collaboration with) one or more content distribution networks 100 and/or intervention analyzer systems 600, described above. Specific examples of such CDN 100s, may include, without limitation, educational and professional training systems and networks, interactive gaming systems and networks, media distribution systems and networks, and enterprise application systems and networks, and/or social networking/dating systems and networks. As discussed below, each of the components shown in example intervention system 700 may correspond to a single computer device or server, or may be a complex computing system including a combination of computing devices, storage devices, network components, etc. Each of these components and their respective subcomponents may be implemented in hardware, software, or a combination thereof.

In this example, client devices 710 are identified as mobile devices as shown communicating with an intervention assessment device 720 via wireless transmissions. In such embodiments, client devices may include desktop or laptop computers, tablet computers, mobile phones, and other mobile devices including some or all of the hardware, software, and networking components discussed above in connection with client devices 610. In this example, client devices 710 may be configured to render and present assessment data objects received from the intervention assessment device 720, as well as transmit user responses to assessment questions and other assessment feedback data back to the intervention assessment device 720. As discussed above, the assessments presented via client devices 710, and the corresponding assessment data transmitted back to the intervention assessment device 720, may relate to assessments for measuring academic skills and abilities of users within an educational or professional training system 100. Such assessments may include assessment questions presented as web-based content or via other user assessment software executing on client devices 710. Additionally or alternatively, such assessments may include live content such as television programming, music, lectures or presentations in a training course or eLearning system, and/or live or delayed interactions (e.g., text, audio, or video interactions) with an assessment administrator using the assessment device 720. Client devices 710 thus may include the necessary hardware and software components to establish the network interfaces, security and authentication capabilities, and content caching capabilities to receive the various potential types of assessment content and/or and provide it to users in real-time (or near real-time).

Mobile devices 710 also may capture assessment question responses and other user feedback data from users in response to the assessments presented, and may transmit the captured assessment data back to the assessment device 720. Accordingly, mobile devices 710 may include one or more assessment data capture devices, such as a keyboard, touchscreen, camera, and/or microphone, which may be integrated with and/or peripheral to the mobile devices 710. Additionally, in some embodiments, the assessment content need not be displayed via mobile devices 710, but may originate from a separate device, conference room or classroom projector, a live speaker, etc. In such examples, the mobile devices 710 might only capture and transmit the user responses as assessment data, and therefore user devices 710 may be special purpose hardware devices such as cameras, microphones, motion detectors, and other sensor devices.

Intervention assessment device 720 may correspond to a single computing device or a combination of devices/servers/storage devices/network components/etc. As discussed below, the intervention assessment device 720 may be configured to transmit assessment content to mobile devices 710, and to receive and analyze the assessment data received from mobile devices 710 in order to determine and initiate interventions for individual records. In order to execute the functions and tasks described herein, the intervention assessment device 720 may be implemented using any combination of the computer hardware, software, storage, and network components discussed above, such as those in illustrative computer system 500, and also may be implemented within any of the computing environments discussed above, such as content distribution network 100 and/or distributed computing environment 200. For example, intervention assessment device 720 may include secure storage device(s) to store assessment content and assessment data received from mobile devices 710 and/or from assessment data stores 730.

Additionally, intervention assessment device 720 may include one or more specialized hardware and/or software components configured to perform similar or identical features to those of the intervention analyzer server 620. As shown in this example, intervention assessment device 720 may include an assessment presentation module 725, which may include specialized software and/or hardware components configured to retrieve assessments from assessment data stores 730, extract and transmit the assessment content to mobile devices 710, and receive assessment data (e.g., user responses to assessment questions, etc.) back from the mobile devices 710. Additionally, intervention assessment device 720 also may include a real-time intervention analyzer service 726, which may include specialized software and/or hardware components configured to analyze the individual assessment data in real-time (or near real-time) in order to determine and initiate the appropriate intervention(s) for the individual user. In some cases, the components of the intervention assessment device 720 may analyze the assessment data received from a mobile device 710 in real-time, potentially determining a match with one or more intervention subtype profiles before receiving all possible assessment data, thereby allowing certain assessments to terminate early. Additionally, the components of the intervention assessment device 720 may determine and transmit assessments and/or assessment questions on-the-fly, in response to assessment data received and analyzed in real-time. Thus, assessments may be presented in a dynamic and intelligent way based on real-time feedback, in order to increase efficiency of the assessment and intervention processes.

In some embodiments, the intervention assessment device 720 may access one or more assessment data stores 730 and/or intervention subtype/cluster profile data stores 740. Data stores 730 and/or 740 may be implemented as databases, file-based storages or other storage systems. In some embodiments, assessment data stores 730 and/or 740 intervention subtype/cluster profile data stores 740 may be implemented within the intervention assessment device 720, or as a separate data storage systems which may provide assessment data objects and intervention profiles data objects to the intervention assessment device 720.

In some cases, intervention assessment device 720 also may be a presentation device used by an assessment administrator (e.g., instructor, counselor, etc.) to present and monitor assessments to users on mobile devices 710. Thus, intervention assessment devices 720 also may be desktop or laptop computers, mobile devices, and other various computing devices/systems, including some or all of the hardware, software, and networking components discussed above in connection with client devices 610. As discussed below, such presentation devices may be configured to receive real-time assessment data from mobile devices 710, including assessment question responses and/or other user assessment feedback. Presenters of live assessment content (e.g., lecturers, instructors, performer, live television program producers, etc.) and/or automated assessment presentation software 725 may use the real-time or (near real-time) assessment data from mobile devices 710 to alter and customize the assessment content.

Real-time intervention systems 700 such as the example shown in FIG. 7 may be implemented on small or large scales, and in one physical locations or across multiple locations. For example, in some embodiments, an intervention assessment device 720 may be operated on the same computing and networking infrastructure and in the same physical location as the set of mobile client devices 710, for example, within a conference room, theater, lecture hall, or class room. In such cases, the communications may occur via LAN, Bluetooth®, NFC, M-RFID, and/or other short-range communication infrastructures. In other embodiments, the intervention assessment device 720 and client devices 710 may operate at remote geographic locations, such as in an remote video conferencing system 100 or live eLearning system 100 having many geographically diverse user devices 710 and/or invention assessment devices 720 at separate locations. In such large scale and geographically diverse implementations, different networking communication protocols and security systems may be implemented, such as WAN, cable, or satellite-based communication using specialized networking equipment such as firewalls, load balancers, and the like.

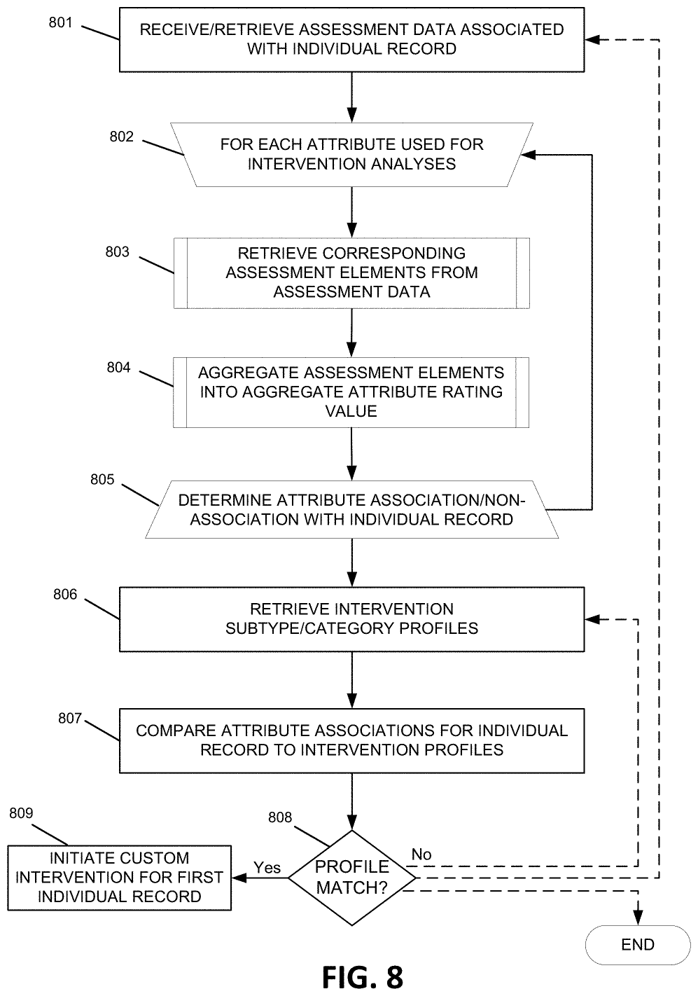

Referring now to FIG. 8, a flow diagram is shown illustrating a process of initiating custom interventions for individual records based on retrieved assessment data and intervention subtype profiles. As described below, the steps in this process may be performed by one or more components in the intervention analyzer systems 600 and/or 700 described above. For example, each of the steps 801-809 may be described below in terms of the intervention analyzer server 620. However, in other examples, some or all of the steps 801-809 described below may be performed by a standalone intervention assessment device 720, and/or one or more client devices 610 or 710. It should also be understood that the various features and processes described herein, including receiving input data via programmatic or graphical interfaces, and generating data corresponding to assessment content and assessment response data need not be limited to the specific systems and hardware implementations described above in FIGS. 1-7.

In step 801, a set of assessment data from one or more assessments may be received/retrieved for an individual record. As discussed above, assessment data may refer to data relating to the abilities, behaviors, and/or achievements of various users within a content distribution network 100. For example, within educational and/or professional training systems and networks 600, assessment data may include test data used to assess a range of academics skills and/or particular areas of need for the system user. Students or trainees in such eLearning systems 600 may be evaluated with respect to basic academic skills, including reading, mathematics, writing, and oral language skills, for example, using Kaufman Test of Educational Achievement (KTEA) assessments, and Wechsler Individual Achievement Test (WIAT) assessments, and various other types of educational system assessments. Such assessments may be administered to users in a variety of different media, scored, and the results stored in assessment data stores 630.

Over time, a single individual (e.g., student, trainee, employee, etc.) may take several assessments and may have corresponding individual assessment results data stored in multiple assessment data stores 630, including both internal data stores 630a associated with and maintained by the intervention analyzer system 600, as well as external data stores 630b-630c stored and maintained remotely from the intervention analyzer system 600. To interact with external data stores, the intervention analyzer server 620 may be configured to identify and query the remote data sources 630b-630c, and to request assessment result data for specific individual users. As such assessment data may be personal and confidential to the individual, the intervention analyzer server 620 and external data stores 630b-630c may be configured to use various authorization techniques and secure transmission protocols.

In some embodiments, the retrieval of an individual's assessment data in step 801 may include an automatic collection of all assessment results associated with the particular individual from any accessible data stores 630. For example, if a particular user has previously taken five (5) reading assessments, then assessment data for all five assessments may be retrieved automatically by the intervention analyzer server 620. In other examples, the intervention analyzer server 620 may provide the user initiating the intervention analysis (e.g., an educator, administrator, counselor, etc.) the option to select a specific subset of assessments to be used in the intervention analysis. For example, the intervention analyzer server 620 may provide programmatic interfaces (e.g., APIs) and/or graphical interfaces allowing the user to select and/or deselect certain assessments of an individual for the intervention analysis.

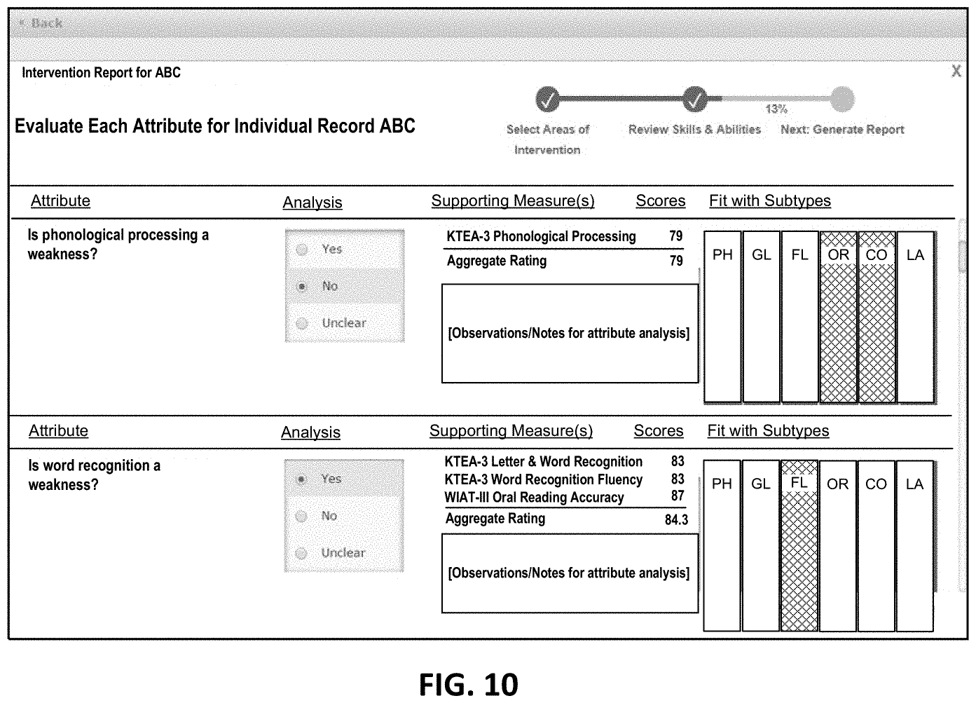

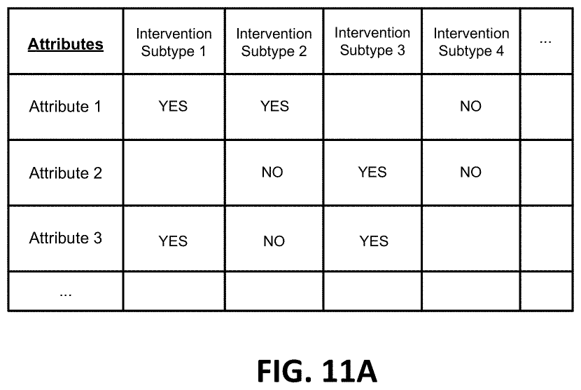

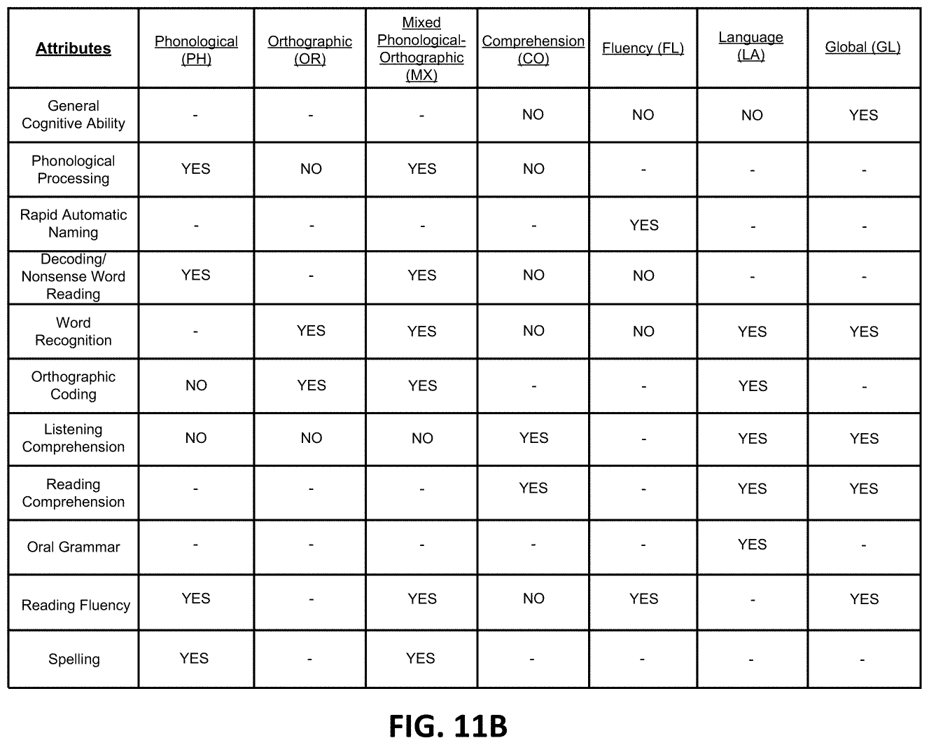

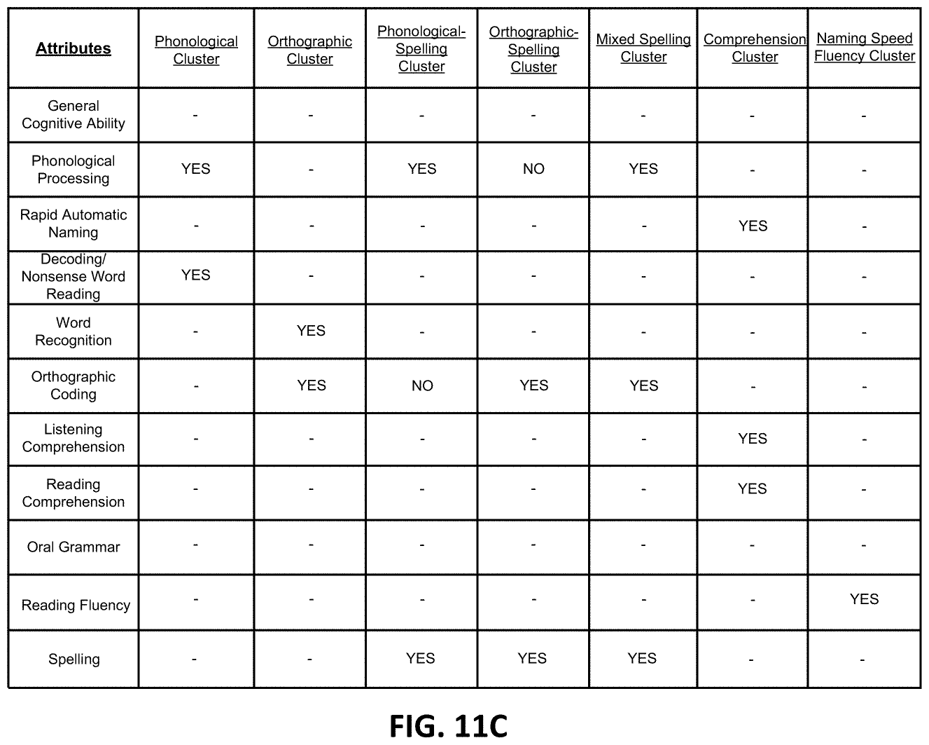

In step 802, a set of attributes is identified corresponding to the assessment data received in step 801, and the intervention analyzer server 620 may perform steps 803-805 separately for each identified attribute. In some cases, attributes may correspond to skills or abilities of the individual being assessed. Continuing with the above example, if the intervention analysis is based on a number reading assessments administered to a user (e.g., student, trainee, employee, etc.) in an educational or professional training CDN 100, then a set of attributes relating to reading skills, abilities, or achievements may be identified in step 802. For instance, an example set of attributes relating to reading assessments are shown (in question form) in the “Attribute” column of FIG. 10, and another example set of attributes for reading assessments is shown in the “Attribute” column of FIGS. 11B-11C.

In step 803, for each attribute identified in step 802, one or more corresponding assessment elements may be retrieved from the assessment data received/retrieved in step 801. As discussed above, the assessment data in eLearning systems 600 may correspond to KTEA or WIAT assessments of academic skills and abilities of individual users. In step 803, the intervention analyzer server 620 may open the assessment data objects retrieved in step 801 and extract (or otherwise determine) specific assessment elements relating to each attribute identified in step 802. For example, the various KTEA and WIAT reading assessments, along with other such assessments, may be organized into different assessment questions, categories, sections, etc., each of which may relate a single attribute of reading skills/abilities or to multiple attribute. The assessment data for an individual user, corresponding to the user's assessment question responses and other user feedback data for the assessments, may be analyzed and parsed by the intervention analyzer server 620 in order to extract the specific assessment responses and feedback for the questions/parts/sections/etc. that relate to each different attribute. The user's assessment data for each attribute may be retrieved and/or determined for each assessment in step 803. In some embodiments, the intervention analyzer server 620 may extract or calculate attribute-specific user scores in step 803 for each assessment. In step 804, the attribute-specific user scores for different assessments may be aggregated by the intervention analyzer server 620 into an aggregated rating value.

For example, referring briefly to FIG. 10, an example screen is shown of a user interface for collecting and analyzing assessment data for an intervention assessment. In this example, two example attributes are displayed (in YES/NO question form) for the user “ABC.” For each attribute shown in FIG. 10, the “Supporting Measure(s)” column lists a number of different assessments, along with the extracted or calculated attribute-specific user scores (step 803) for that assessment. Additionally, below the list of assessments for each attribute, an aggregate rating value has been calculated (step 804) for the user with respect to the attribute. In this example, the aggregate rating values calculated in step 804 are averages of the extracted or calculated attribute-specific user scores for the different attributes, although other techniques may be used in other examples, such as weighting different assessments differently, discarding outlier assessments, etc. Additionally, although a graphical user interface is generated and provided in this example to display the assessment data scores and aggregate rating values for each attribute, a graphical user interface need not be displayed in other examples. For instance, the intervention analyzer server 620 may automatically extract and/or calculate the attribute-specific user score for each individual assessment, and then may calculate the attribute aggregate rating values, without needing to provide a user interface to any client device 610 or receive any user input from client devices 610.

In step 805, for each attribute identified in step 802, the assessment data for the individual user record may be used to determine whether the individual user is associated with or not associated with the attribute. In some embodiments, the determination in step 805 may be an automated determination performed by the intervention analyzer server 620 for some or all of the attributes. For example, the intervention analyzer server 620 may compare the aggregate rating values calculated in step 804 to an attribute-specific threshold value. If the aggregate rating values exceeds the attribute-specific threshold value, the individual user record may be determined to be associated with the attribute, and if not, the individual user record may be determined not to be associated with the attribute. In other embodiments, the determination in step 805 may include a combination of automated and manual steps. For instance, referring again to FIG. 10, the intervention analyzer server 620 may calculate and present the attribute-specific user scores and aggregate rating value for each attribute via the user interface. The intervention analyzer server 620 in this example also may present a set of observations and/or notes associated with each attribute, and may provide user interface components to allow the user to select whether or not the individual user record is associated with the attribute. In this case, the user may select one of three options (Yes, No, or Unclear) in the “Analysis” column for each attribute, to define the association or lack of association between the attribute and the record for user ABC.

In step 806, the intervention analyzer server 620 may retrieve a set of intervention subtype profiles and/or intervention category profiles associated with the type of intervention analysis being performed. For example, continuing with the above example, if the intervention analysis for a user is based on the reading assessments administered to that user via an educational or professional training CDN 100, then a set of set of intervention subtype profiles may relate to the reading skills, abilities, or achievements of the user. In some cases, intervention subtype and/or category profiles may correspond to certain types of learning disability or particular aptitudes within the assessment area. For instance, referring to FIGS. 11A-11C, three different examples are shown of tables representing intervention subtype and/or category profiles. FIG. 11A is a general example of intervention subtype profile, in which the data structure stores one of the three values (Yes, No, or Null) for each combination of an attribute and a intervention subtype. FIGS. 11B and 11C are specific examples of intervention subtype profiles (FIG. 11B) and intervention category profiles (FIG. 11C) for performing an intervention analysis based on reading assessment data. In some embodiments, some or all of the intervention categories may be related to one or more intervention subtypes, but may be broader than their related subtypes. For instance, the “Phonological Cluster” shown in FIG. 11C corresponds to set of attributes related to but broader than the “Phonological Subtype” shown in FIG. 11B, because any user that would be classified within the “Phonological Subtype” would also be classified within the “Phonological Cluster,” but the opposite is not true. As described below, related intervention clusters may allow the intervention analyzer server 620 to initiate interventions even when a user has not been classified within an intervention subtype.

In step 807, the associations determined in step 805 between the individual user record and the attributes (including the determined lack of associations), are compared to each of the intervention subtype profiles retrieved in step 806. In some embodiments, every positive association (e.g., the YES's in FIGS. 11A-11C), as well as every negative association (e.g., the NO's in FIGS. 11A-11C) must correspond in order to determine that an individual user record is a match for an intervention subtype. In other embodiments, the intervention analyzer server 620 may use an error tolerance when matching users to intervention subtypes, and/or may determine partial matches for users with respect to intervention subtypes, in which not every positive and negative association must correspond. In the example shown in FIG. 11, the intervention subtype profiles are mutually exclusive, in that no individual user record can be classified into two different intervention subtypes; however, in other examples classification into multiple intervention subtypes may be supported.

In step 808, if the intervention analyzer server 620 determines that the individual user record matches one or more intervention subtypes (808:Yes), then the server 620 may initiate an intervention in step 809 based on the individual user record. In various different embodiments, interventions based on interventions subtype classifications may include automated notifications to client devices 610 associated with the individual user and/or other related client devices. For example, in the case of intervention analyses based on reading assessment data of a user within an educational or professional training CDN 100, and/or for other academic assessments, performing interventions may include generating and transmitting custom notifications to client devices 610 of instructors, administrators, or counselors associated with the individual user. Additionally, custom intervention assessment reports may be generated in step 809 based on the interventions subtype classifications of the user and other user-specific assessment data.

As shown in FIG. 8, if the intervention analyzer server 620 does not identify one or more intervention profile matches for individual user record (808:No), then the server 620 may proceed down one or more subsequent processing paths. In some examples, the intervention analyzer server 620 may determine that the individual user record does not match any intervention profiles retrieved in step 806, and may simply end the process.

In other examples, the intervention analyzer server 620 may return to step 801, where the assessment data used in the process may be added to or modified in various ways before re-executing the intervention analysis process steps 802-809. For instance, if the intervention analyzer server 620 does not identify one or more intervention profile matches for individual user record (808:No), it may provide an updated user interface in step 801 to allow a user to select or de-select different sets of assessments to be used in the intervention analysis. By retrieving additional assessments from internal or external data stores 630, and/or by changing the selections of assessments to be used in the analysis, the subsequent assessment attribute scores (step 803) and aggregate rating values (step 804) may change when recalculated, and so may the classification of the individual record into an intervention subtype in step 808.

In still other examples, the intervention analyzer server 620 may return to step 806, where the same assessment data may be used, but different sets of intervention profiles may be retrieved and compared against the assessment data for the individual user record. For instance, in some embodiments, the first iteration of step 806 may retrieve a set of intervention subtype profiles only (e.g., FIG. 11B), and the next iteration of step 806 may retrieve a set of intervention cluster profiles (e.g., FIG. 11C) which are related to but broader than the intervention subtype profiles. Accordingly, the subsequent iteration of step 808 potentially may be successful in classifying the individual record into an intervention cluster, even though it could not be classified into an intervention subtype.

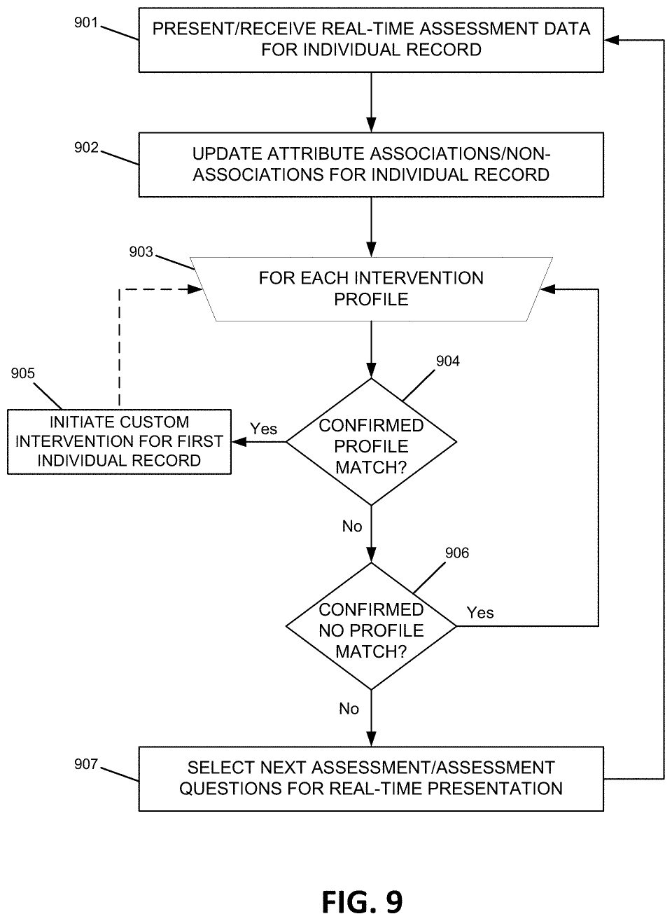

Referring now to FIG. 9, a flow diagram is shown illustrating another process of initiating custom interventions for individual records based on retrieved assessment data and intervention subtype profiles. In this example, customer interventions may be determined and initiated based on assessment data received and analyzed in real-time from one or more client devices. The steps in this process also may be performed by one or more components in the intervention analyzer systems 600 and/or 700 described above. For example, each of the steps 901-907 may be described below in terms of the intervention assessment device 720. However, in other examples, some or all of the steps 901-907 described below may be performed by an intervention analyzer server 620 and/or other devices within intervention systems 600 and 700, including one or more client devices 610 or 710. It should also be understood that the various features and processes described herein, including presenting assessment content and receiving real-time assessment response data, and identifying and initiating interventions, need not be limited to the specific systems and hardware implementations described above in FIGS. 1-7.

In step 901, assessment content may be presented and assessment response data may be received in real-time, for example, from an intervention assessment device 720 and to a client device 710. As discussed above in reference to FIG. 7, the assessment presentation module 725 of the intervention assessment device 720 may retrieve assessments from internal and/or external assessment data stores 730, and then extract and transmit the assessment content to mobile devices 710. In some cases, the assessment content may include sequences of interactive assessment questions that may be presented in a predetermined order to a client device 710. The real-time intervention analyzer service 726 of the intervention assessment device 720 may analyze the responses to the assessment questions received from the client 710 data in real-time (or near real-time). In this example, steps 902-907 of the intervention analysis may be performed after each assessment question response (or other real-time assessment feedback from the user) is received in step 901. In other examples, steps 902-907 need not be performed after response received from the client device 710, but may be performed at the completion of each section/sub-section/part of a real-time assessment.

In step 902, the intervention assessment device 720 may determine and/or update the associations between the individual user and the attributes (including the determined lack of associations between users and attributes) for the intervention analysis, based on the new assessment data received in step 901. Accordingly, the processes and techniques used to perform step 902 may be similar or identical to those in steps 802-805, discussed above.

In step 903, the intervention assessment device 720 may iteratively retrieve an intervention subtype and/or cluster profile, and in step 904 may compare the current set of assessment data received for the individual record to the intervention profile. Accordingly, the processes and techniques used to perform steps 703-704 may be similar or identical to those in steps 806-807, discussed above.

If the current set of assessment data received for the individual record is sufficient to determine that the individual record matches the intervention profile retrieved in step 903 (904:Yes), then the intervention assessment device 720 may immediately initiate a custom intervention in step 905, using techniques similar or identical to those discussed above in step 809. If the current set of assessment data received for the individual record is not sufficient to determine that the individual record matches intervention profile retrieved in step 903 (904:No), then the intervention assessment device 720 may further analyze the data in step 905 to determine whether the current set of assessment data received for the individual record is sufficient to determine that the individual record does not match intervention profile (904:No).

To illustrate, referring again to the invention cluster profile table in FIG. 11C, if the current set of assessment data for an individual user record is sufficient to determine that the user has the “Phonological Processing” attribute and the “Decoding/Nonsense Word Reading” attribute, then in step 904 the intervention assessment device 720 may determine that the current real-time assessment data is sufficient to determine that the user record matches the “Phonological Cluster” profile (904:Yes). In this case, a custom intervention may immediately be initiated in step 905 based the classification of the user into the phonological cluster for reading assessment data. As discussed above, this classification based on the real-time data may allow the ongoing assessment process to terminate early. As indicated by the dotted line in FIG. 9, in some embodiments, the intervention assessment device 720 may continue to compare the individual record assessment data to all other subtypes/clusters after a first matching subtype or cluster is found. Accordingly, the custom interventions initiated in step 905 may be based on the classification of an individual user record into a single intervention subtype or cluster, or into multiple intervention subtypes and/or clusters.

Using a similar example with the invention cluster profile table in FIG. 11C, if the current set of assessment data for a different individual user record is sufficient to determine that the user does not have the “Decoding/Nonsense Word Reading” attribute, then in step 906 the intervention assessment device 720 may determine that the current real-time assessment data is sufficient to determine that the user record does not match the “Phonological Cluster” profile (906:Yes). In this case, the intervention assessment device 720 may return to processing step 903 to repeat the association/non-association determinations for each of the intervention profiles.

If the current set of assessment data for an individual user record is not sufficient to determine that the individual user record matches a profile (904:No), and also is not sufficient to determine that the individual user record does not matches the profile (906:No), then intervention assessment device 720 may proceed to step 907 to select additional assessment content (e.g., specific assessment questions, parts, sections, etc.) which will be subsequently presented via the client device 710 in step 901. Accordingly, using the techniques of FIG. 9, assessments may be presented in a dynamic and intelligent way based on real-time feedback, in order to increase efficiency of the assessment and intervention processes.

A number of variations and modifications of the disclosed embodiments can also be used. Specific details are given in the above description to provide a thorough understanding of the embodiments. However, it is understood that the embodiments may be practiced without these specific details. For example, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

What is claimed is:

1. A system comprising:
a database storing:
a user profile data associated in the database with a user;
a plurality of assessment questions;
a plurality of assessment data associated with the user profile data; and
an intervention profile data;
a computing device coupled to a network and comprising at least one processor executing instructions within a memory which, when executed, cause the computing device to:
transmit, to a client device, an assessment question in the plurality of assessment questions, the assessment question being associated in the database with an assessment attribute;
receive, from the client device, a first real-time assessment response;
responsive to the assessment attribute indicated by the first real-time assessment response not matching an intervention attribute in the intervention profile data:
execute a first database command selecting, from the database and based on the first real-time assessment response, a subsequent assessment question in the plurality of assessment questions;
transmit, to the client device, the subsequent assessment question;
receive, from the client device, a second real-time assessment response;
execute a second database command selecting, from the database, an assessment data in the plurality of assessment data associated with the assessment attribute;
calculate, from the second real-time assessment response and the assessment data, an aggregate attribute-specific user score;
responsive to the aggregate attribute-specific user score exceeding a predefined threshold,
identify, within the intervention profile data:
the intervention attribute matching the assessment attribute; and
an intervention recommendation to improve an aptitude of the user relating to the assessment attribute; and
generate a recommendation report, customized to the user profile according to the aggregate attribute-specific user score and the intervention recommendation, and including the intervention recommendation.

2. The system of claim 1, wherein the instructions further cause the computing device to:
execute a database command selecting, from the database, the plurality of assessment data; and
identify, within the plurality of assessment data, a plurality of test data assessing a range of skills associated with the user profile data.

3. The system of claim 1, wherein the instructions further cause the computing device to generate a Graphical User Interface (GUI) comprising:
the aggregate attribute-specific user score;
the assessment question; and
an assessment response GUI component configured to receive user input indicating a positive response or a negative response to the assessment question.

4. The system of claim 3, wherein the instructions further cause the computing device to generate, within the GUI:
a notes and observations GUI component receiving user input comprising a plurality of notes and observations associated with the first real-time assessment response; and
a graphical representation of the intervention attribute matching the assessment attribute.

5. A method comprising:
storing, by a computing device coupled to a network and comprising at least one processor executing instructions within a memory, within a database:
a user profile data associated in the database with a user;
a plurality of assessment data associated with the user profile data; and
an intervention profile data;
executing, by the computing device, a database command selecting, from the database, the plurality of assessment data;
identifying, by the computing device within the plurality of assessment data, an assessment attribute;
calculating, by the computing device from the plurality of assessment data, an attribute-specific user score;
responsive to the attribute-specific user score exceeding a threshold stored in the database:
identifying, by the computing device, within the intervention profile data:
an intervention attribute matching the assessment attribute; and
an intervention recommendation to improve an aptitude of the user relating to the assessment attribute; and
generating, by the computing device, a Graphical User Interface (GUI) comprising a recommendation report, customized to the user profile according to the attribute-specific user score and the intervention recommendation, and including the intervention recommendation.

6. The method of claim 5, further comprising the steps of:
storing, by the computing device within the database, a plurality of assessment questions;
generating, by the computing device for display on the GUI, an assessment question in the plurality of assessment questions, the assessment question being associated in the database with the assessment attribute;
transmitting, by the computing device to the client device, the GUI;
receiving, by the computing device from the client device, a first real-time assessment response;
calculating, by the computing device, an aggregate attribute-specific user score from the first real-time assessment response and the plurality of assessment data; and
re-generating, by the computing device, the recommendation report, according to the aggregate attribute-specific user score.

7. The method of claim 6, further comprising the steps of displaying, by the computing device on the GUI:
the attribute-specific user score;
the assessment question; and
a first real-time assessment response GUI component configured to receive user input indicating a positive response or a negative response to the assessment question.

8. The method of claim 6, further comprising the steps of: responsive to the assessment attribute indicated by the first real-time assessment response not matching the intervention attribute in the intervention profile data:
executing, by the computing device, a first database command selecting, from the database and based on the first real-time assessment response, a subsequent assessment question in the plurality of assessment questions;
transmitting, by the computing device to the client device, the subsequent assessment question;
receiving, by the computing device from the client device, a second real-time assessment response;
re-calculating, by the computing device, the aggregate attribute-specific user score from the first real-time assessment response, the plurality of assessment data, and the second real-time assessment response; and
re-generating, by the computing device, the recommendation report, according to the aggregate attribute-specific user score.

9. The method of claim 5, further comprising the steps of:
receiving, by the computing device from an assessment selection GUI component displayed on the client device, at least one selected assessment data; and
executing, by the computing device, a database command selecting the at least one selected assessment data from the plurality of assessment data in the database.

10. The method of claim 6, further comprising the step of generating, by the computing device within the GUI:
a notes and observations GUI component receiving user input comprising a plurality of notes and observations associated with the first real-time assessment response; and
a graphical representation of the intervention attribute matching the assessment attribute.

11. The method of claim 5, further comprising the steps of:
executing, by the computing device, a database command selecting, from the database, the plurality of assessment data;
identifying, by the computing device, within the plurality of assessment data, a plurality of test data assessing a range of skills associated with the user profile data.

12. A system comprising a computing device coupled to a network and comprising at least one processor executing instructions within a memory, the computing device being configured to:
store, within a database:
a user profile data associated in the database with a user;
a plurality of assessment data associated with the user profile data; and
an intervention profile data;
execute a database command selecting, from the database, the plurality of assessment data;
identify, within the plurality of assessment data, an assessment attribute;
calculate, from the plurality of assessment data, an attribute-specific user score;
responsive to the attribute-specific user score exceeding a threshold stored in the database:
identify, within the intervention profile data:
an intervention attribute matching the assessment attribute; and
an intervention recommendation to improve an aptitude of the user relating to the assessment attribute; and
generate a Graphical User Interface (GUI) comprising a recommendation report, customized to the user profile according to the attribute-specific user score and the intervention recommendation, and including the intervention recommendation.

13. The system of claim 12, wherein the computing device is further configured to:
store, within the database, a plurality of assessment questions;
generate, for display on the GUI, an assessment question in the plurality of assessment questions, the assessment question being associated in the database with the assessment attribute;
transmit the GUI to the client device;
receive, from the client device, a first real-time assessment response;
calculate an aggregate attribute-specific user score from the first real-time assessment response and the plurality of assessment data; and
re-generate the recommendation report, according to the aggregate attribute-specific user score.

14. The system of claim 13, wherein the computing device is further configured to display on the GUI:
the attribute-specific user score;
the assessment question; and
a first real-time assessment response GUI component configured to receive user input indicating a positive response or a negative response to the assessment question.

15. The system of claim 13, wherein the computing device is further configured to:
responsive to the assessment attribute indicated by the first real-time assessment response not matching the intervention attribute in the intervention profile data:
execute a first database command selecting, from the database and based on the first real-time assessment response, a subsequent assessment question in the plurality of assessment questions;
transmit, to the client device, the subsequent assessment question;
receive, from the client device, a second real-time assessment response;
re-calculate the aggregate attribute-specific user score from the first real-time assessment response, the plurality of assessment data, and the second real-time assessment response; and
re-generate the recommendation report, according to the aggregate attribute-specific user score.

16. The system of claim 12, wherein the computing device is further configured to:
receive, from an assessment selection GUI component displayed on the client device, at least one selected assessment data; and
execute a database command selecting the at least one selected assessment data from the plurality of assessment data in the database.

17. The system of claim 12, wherein the computing device is further configured to generate, within the GUI:
a notes and observations GUI component receiving user input comprising a plurality of notes and observations associated with the first real-time assessment response; and
a graphical representation of the intervention attribute matching the assessment attribute.

18. The system of claim 12, wherein the computing device is further configured to:
execute a database command selecting, from the database, the plurality of assessment data; and
identify, within the plurality of assessment data, a plurality of test data assessing a range of skills associated with the user profile data.

19. The system of claim 12, wherein the computing device comprises:
a server computing device;
a second server computing device separate from the server computing device; or the client device.
